(19) United States
(12) Patent Application Publication
(10) Pub. No.: US 2014/0212842 A1
(43) Pub. Date: Jul. 31, 2014

(54) DENTAL PROSTHESIS

(71) Applicant: Gerwin Vincent Arnetzl, Graz (AT)

(72) Inventor: Gerwin Vincent Arnetzl, Graz (AT)

(73) Assignees: REDTENBACHER PRAEZISIONSTEILE GMBH, Scharnstein (AT); Gerwin Vincent ARNETZL, Graz (AT)

(21) Appl. No.: 14/238,263

(22) PCT Filed: Aug. 1, 2012
(86) PCT No.: PCT/AT2012/050111

§ 371 Date: Mar. 21, 2014

(30) Foreign Application Priority Data
Aug. 12, 2011 (AT) A 1170/2011

(51) Int. Cl. A61C 8/00

(52) U.S. Cl. CPC A61C 8/0066; A61C 8/0068
USPC 433/173

(57) ABSTRACT

The invention relates to a dental prosthesis, comprising an implant body (1) and an abutment (2) that can be inserted into a receptacle of the implant body (2), said abutment forming a passage opening (5) for accommodating a head screw (4) that engages in a female thread (6) of the implant body (1) and supports a tooth structure (3) secured against twisting. In order to ensure simple constructional conditions it is proposed that the head (7) of the head screw (4) is connected in an interlocking manner to an anti-rotation device (9) which can only be twisted together with the head screw (4) and which is glued together with the tooth structure (3).

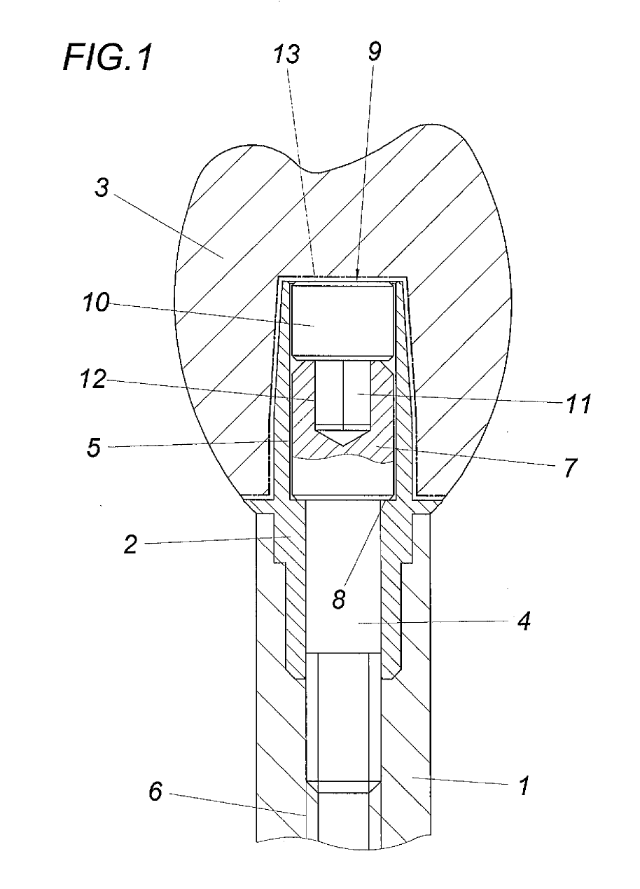

### FIELD OF THE INVENTION

The invention relates to a dental prosthesis, comprising an implant body and an abutment that can be inserted into a receptacle of the implant body, said abutment forming a passage opening for accommodating a head screw that engages in a female thread of the implant body and supports a tooth structure secured against twisting.

### DESCRIPTION OF THE PRIOR ART

In the application of dental prostheses, an implant body is usually inserted into the jawbone and is provided with an abutment for accommodating a tooth structure such as a dental crown. This abutment is connected by means of a head screw to the implant body which is inserted into a passage opening of the abutment and engages in a female thread of the implant body. The screw cap rests on an annular shoulder of the abutment, wherein it is necessary that the head screw is unable to loosen inadvertently and enables a tight connection to the abutment, so that no bacteria can reach the implant body. In order to meet these requirements, it is known (DE 103 40 059 A1, DE 20 2006 013 585 U1) to provide the screw cap with a conical head part which rests on a conical annular shoulder. Although this conical arrangement of the support surfaces leads to an improvement concerning the support of the screw cap in relation to the abutment, these known screw connections can fulfil the demands placed thereon only to a certain extent.

It has been proposed to secure the head screw against twisting relative to the abutment (EP 1362560 A1) to provide at least one groove for accommodating a featherkey in the head of the head screw, which featherkey engages in respective recesses of the abutment. It is disadvantageous in such an anti-rotation device that the head screw can be secured against inadvertent twisting only in fixedly predetermined rotary positions in which the grooves of the head screw are in alignment with the recesses of the abutment.

### SUMMARY OF THE INVENTION

The invention is therefore based on the object of providing a dental prosthesis of the kind mentioned above in such a way that a secure screwed connection is ensured between the abutment and the implant body in any rotary position of the head screw even over prolonged periods of time.

This object is achieved by the invention in such a way that the head of the head screw is connected in an interlocking manner to an anti-rotation device which can only be twisted together with the head screw and which is glued together with the tooth structure.

By providing an anti-rotation device which is connected to the head of the head screw in an interlocking manner, the head screw can only be twisted together with the anti-rotation device, so that during a twist-proof fixing of the anti-rotation device it is ensured that the head screw is unable to loosen. The twist-proof fixing of the anti-rotation device occurs in a simple way by a glued connection of the anti-rotation device with the tooth structure, which needs to be held in a twist-proof manner on the abutment, usually by way of an adhesive layer. Loosening of the head screw is effectively prevented by the twist-proof support of the anti-rotation device in relation to the tooth structure. Despite the anti-twist security of the head screw, the abutment can be changed if necessary because after the removal of the tooth structure by loosening the glued connection and a removal of the anti-rotation device the head of the head screw is freely accessible again.

Since the head screws for the connection of the abutment with the implant body generally comprise an insertion receptacle for an actuating tool in form of a hexagon of the head, especially simple constructional conditions are achieved when this insertion receptacle is used for the interlocking connection of the screw cap with the anti-rotation device, because in this case the anti-rotation device can be arranged as a simple insert which engages in an interlocking fashion into the insertion receptacle of the head of the head screw which is provided for an actuating tool.

If the anti-rotation element is flush with the abutment, advantageous gluing conditions are obtained because it is not necessary to take the gluing of the anti-rotation device with the tooth structure into account in the configuration of the tooth structure. The anti-rotation device forms an adhesive surface which substantially seals the passage opening of the abutment, so that no bacteria can reach the implant body by an adhesive layer between the tooth structure and the anti-rotation device, which adhesive layer bridges the annular gap between the anti-rotation device and the abutment.

### BRIEF DESCRIPTION OF THE DRAWINGS

The subject matter of the invention is shown by way of example in the drawing, which shows a dental prosthesis in accordance with the invention in a schematic longitudinal sectional view.

### DESCRIPTION OF THE PREFERRED EMBODIMENT

The dental prosthesis according to the embodiment comprises in the conventional manner an implant body 1 to be inserted into the jawbone for accommodating an abutment 2, which acts as a support for a tooth structure 3 which in the embodiment consists of an implant crown. The connection between the abutment 2 and the implant body 1 occurs by way of a head screw 4, which is inserted into a passage opening 5 of the abutment 2 and engages in a female thread 6 of the implant body 1. The head 7 of the head screw 4 is supported on an annular shoulder 8 of the abutment 2, so that the abutment 2 can be connected in a tension-proof manner to the implant body 1 via the head screw 4.

The relevant aspect for this screwed connection between the abutment 2 and the implant body 1 is that loosening of the head screw 4 is also prevented over prolonged periods of time. For this purpose, an anti-rotation device 9 is provided for the head screw 4 which is connected in an interlocking manner with the head 7 of the head screw 4. This anti-rotation device 9 is advantageously arranged as an insert 10 which engages in an interlocking manner with an insertion projection 11 into the insertion receptacle 12 of the head 7 for an actuation tool. Said insertion receptacle 12 is usually formed as a hexagon socket, so that the insertion projection 11 has a respective hexagonal cross-section.

In order to ensure that the anti-rotation device 9 can be held in a simple twist-proof manner in relation to the abutment 2, the anti-rotation device 9 is glued together on the front face with the tooth structure 3, which on its part is glued together with the abutment 2. The gluing layer 13 is schematically indicated by a dot-dash line, Since the front face of the anti-rotation device 9 is flush with the abutment 2, a gluing area which is substantially continuous over the passage opening 5 of the abutment 2 is obtained between the tooth structure 3 and the anti-rotation element 9, so that the anti-rotation device 10 is held in a twist-proof fashion in relation to the abutment 2 by way of the adhesive layer 13. For the purpose of producing this connection which is secured against loosening of the head screw 7, it is merely necessary, after the fixing of the abutment by the head screw 4, to insert the anti-rotation device 9 preferably in form of the insert 10 into the insertion receptacle 12 of the head 7 of the head screw 4 before the tooth structure 3 is fixed in the conventional manner to the abutment 2 by means of an adhesive layer 13. After the curing of the adhesive layer 13, not only is the tooth structure 3 is tightly connected to the abutment 2, but the head screw 4 is also held in a twist-proof manner against loosening.

1. A dental prosthesis, comprising an implant body (1) and an abutment (2) that can be inserted into a receptacle of the implant body (2), said abutment forming a passage opening (5) for accommodating a head screw (4) that engages in a female thread (6) of the implant body (1) and supports a tooth structure (3) secured against twisting, wherein the head (7) of the head screw (4) is connected in an interlocking manner to an anti-rotation device (9) which can only be twisted together with the head screw (4) and which is glued together with the tooth structure (3).

2. A dental prosthesis according to claim 1, wherein the anti-rotation device (9) forms an insert (10) which engages in an insertion receptacle (12) of the head (7) of the head screw (4), which receptacle is provided for an actuation tool.

3. A dental prosthesis according to claim 1, wherein the anti-rotation device (9) is flush with the abutment (2).
